(19) United States
(12) Patent Application Publication
(10) Pub. No.: US 2011/0170182 A1
(43) Pub. Date: Jul. 14, 2011

(54) DEVICE FOR HOLDING AND POSITIONING A SAMPLE RELATIVE TO A MICROSCOPE LENS

(76) Inventors: Helmut Lippert, Jena (DE); Christopher Power, Jena (DE); Christian Dietrich, Jena (DE); Benno Radt, Jena (DE)

(21) Appl. No.: 13/056,417

(22) PCT Filed: Jul. 28, 2009
(86) PCT No.: PCT/EP09/05443

§ 371 Date: Mar. 22, 2011

(30) Foreign Application Priority Data
Jul. 31, 2008 (DE) 10 2008 035 933.5

(51) Int. Cl. G02B 21/26

(52) U.S. Cl. 359/391

(57) ABSTRACT

An arrangement for holding and positioning a sample in the detection area of the objective of a microscope, the detection area being located in a chamber which is filled with an immersion liquid. This arrangement includes (1) a sample holder to which the sample is affixed so as to lie upon a point P in a coordinate system X, Y, Z, coordinate Z being defined by the optical axis of the microscope objective and the coordinate origin laying within the detection area, (2) a device by which the position of point P can be varied within the coordinate system X, Y, Z, wherein the range of variation comprehends the detection area, and (3) a device for rotating the sample affixed to the sample holder around point P, wherein a straight line G which encloses with coordinate Z an angle α whose size can be changed is the axis of rotation.

The present application claims priority from PCT Patent Application No. PCT/EP2009/005443 filed on Jul. 28, 2009, which claims priority from German Patent Application No. DE 10 2008 035 933.5 filed on Jul. 31, 2008, the disclosure of which is incorporated herein by reference in its entirety.

### BACKGROUND OF THE INVENTION

1. Field of the Invention

The invention is directed to an arrangement for holding and positioning a sample in the detection area of the objective of a microscope, wherein the detection area is located in a chamber which is filled with an immersion liquid.

The arrangement according to the invention can be applied particularly in connection with single plane illumination microscopy (SPIM), also known as selective plane illumination microscopy.

Basically, in the SPIM technique fluorophores which are contained in the sample or have been introduced into the sample are excited by laser light which is shaped to form a light sheet, as it is called, or is guided over the sample in such a way that the shape of a light sheet results for the period of time during which the sample is observed. In so doing, a plane in the depth of the sample is illuminated by a light sheet. By means of this illumination, an image of the sample in this plane is acquired. In this connection, it is important that the direction in which light is detected is perpendicular to, or at least at an angle other than zero degrees relative to, the plane in which illumination is carried out.

2. Description of Related Art

SPIM technology is described, for example, in Stelzer et al., Optics Letters 31, 1477 (2006), Stelzer et al., Science 305, 1007 (2004), DE 102 57 423 A1, and WO 2004/0530558 A1.

These publications disclose, among others, a sample holder which makes it possible to align the sample for the purpose of obtaining three-dimensional image data from different viewing directions. To this end, the sample is embedded in a gel which is shaped to form a circular cylinder, and this gel cylinder is inserted into a sample chamber that is filled with an immersion medium, for example, water. The refractive index of the gel must not differ substantially from the refractive index of the surrounding immersion medium.

The gel cylinder is supported in such a way that it can be displaced translationally within the sample chamber for recording images and, optionally, can also be rotated around its axis of rotation which extends in the direction of gravitational force.

In the prior art, the optical axis of the detection objective which collects the deflection light coming from the sample is oriented approximately perpendicular to the axis of rotation of the gel cylinder.

The translation and rotation of the sample can be achieved in two different ways. First, the optics can be moved in a complicated manner; second, the sample can be moved directly.

The latter is achieved in the prior art, at least for rotation, in that a drive is connected directly to a holder holding the sample. However, the drive holder and drive arrangement complicates or hampers direct access of the sample to the interior of the chamber, which makes it problematic to position and align the sample. It is also difficult to arrange additional instruments for manipulating the sample.

### SUMMARY OF THE INVENTION

Therefore, it is the object of the invention to provide an arrangement which allows the sample to be positioned in the detection area and oriented relative to the optical axis of the objective under the conditions mentioned above with as many degrees of freedom as possible with respect to the movement of the sample.

According to the invention, an arrangement of the type described above is outfitted with the following:
a sample holder to which the sample is affixed so as to lie upon a point P in a coordinate system X, Y, Z, wherein
   coordinate Z is defined by the optical axis of the objective, and
   the coordinate origin lies within the detection area,
a device by which the position of point P, including the sample affixed to the sample holder, can be varied within the coordinate system X, Y, Z, wherein the range of variation comprehends the detection area, and
a device for rotating the sample affixed to the sample holder around point P, wherein a straight line G which encloses with coordinate Z an angle α whose size can be changed is the axis of rotation.

In an uncomplicated manner, this arrangement ensures, first, that the sample can be displaced in the detection area of the objective even when the point P upon which the sample lies is initially located outside the coordinate origin, and, second, that the orientation of the sample relative to the detection area and, therefore, relative to the optical axis of the objective can be varied in such a way by rotating around point P that it is possible to observe the sample from different viewing directions.

By point P is meant a point P(x, y, z) with any coordinates x, y, z within the coordinate system X, Y, Z.

By positioning is meant within the meaning of the present invention the arrangement of the sample in the detection area of the objective so that the sample, or portions or areas thereof, can be observed. Within the meaning of the present invention, therefore, positioning is carried out when the sample lying upon point P has been displaced in the coordinate origin.

The expression “orientation” refers to the adjustment of a viewing direction or of different viewing directions on the sample which are defined by the optical axis of the objective.

In a first preferred embodiment of the arrangement according to the invention, a device is advantageously provided for displacing the sample affixed to the sample holder along the straight line G, wherein the vertex of angle α is included in the displacement path. In this connection, it is further advantageous when a device for displacing the position of the vertex in direction of coordinate Z is also provided, wherein the detection area is included in the displacement path.

In addition to this, a device for varying the size of angle α is optionally provided, this device preferably being formed in such a way that the angle α can be changed within a range of α=±90°.

In a second preferred embodiment, the arrangement according to the invention is additionally outfitted with a swiveling device for varying the angle β enclosed by coordinate Z and the plane E in which angle α lies, wherein the swiveling axis intersects coordinate Z at right angles. In this connection, the variation of the size of angle β should be provided within a range of β=±90°.

This makes it possible for the operator to acquire additional viewing directions on the sample.

A third preferred embodiment of the arrangement according to the invention optionally provides a device which makes it possible to rotate the swiveling device by an angle γ around the axis parallel to coordinate Z, preferably within a range of up to 360°. This device facilitates handling of the sample with respect to its orientation relative to the objective.

In a fourth preferred embodiment, a device for displacing the sample holder with the sample affixed thereto in direction of coordinate X and/or in direction of coordinate Y can optionally be provided for the purpose of positioning the sample in the detection area.

In all of the embodiments described above, the sample holder can be constructed, for example, as a pin or hollow cylinder whose center axes lie in the straight line G.

The sample holder is preferably constructed as a hollow cylinder, and the sample is held at the sample holder because of a below-atmospheric pressure prevailing in the interior of the hollow cylinder. For the purpose of generating the negative pressure, the interior of the hollow cylinder can communicate with a vacuum pump via a hose line or with a displaceable suction-and-pushing piston.

When the sample holder is constructed as a pin, the sample can be affixed to an end of the pin, for example, by impaling it thereon, or by means of a clamp.

In so doing, it is conceivable and possibly advantageous when one or more samples affixed to the sample holder are enclosed by a hydro gel, preferably an agarose gel.

The device for changing the size of the angle α can have, for example, a sliding guide with a guide curve which is curved in a half-circle around the vertex of angle α. The sliding guide can be constructed as a subassembly of the swiveling device and, as such, can be supported in such a way that it can be inclined by angle β toward the coordinate Z.

In this regard, it is conceivable to attach additional units besides the sample holder, for example, units which are to be used for mechanical, optical, electrical or acoustical manipulation of the sample and which are moved parallel to the sample holder.

Particularly when using the arrangement according to the invention in connection with single plane illumination microscopy, the illumination of the sample can be carried out by a beam path shaped as a light sheet which is directed to the sample parallel to the plane enclosed by coordinates X and Y.

### BRIEF DESCRIPTION OF THE DRAWINGS

FIG. 1 shows different constructional variants of a sample holder associated with the arrangement according to the invention;

FIG. 2 shows an example for positioning a sample affixed to the sample holder according to FIG. 1a in the detection area of a microscope objective, wherein the detection area is located in a chamber filled with an immersion liquid;

FIG. 3 shows a first constructional variant of the arrangement according to the invention which allows the sample to be positioned in the detection area in a simple manner and which allows the orientation of the sample relative to the optical axis of the objective to be varied in a simple manner; and

FIG. 4 shows a second constructional variant of the arrangement according to the invention which allows the sample to be positioned in the detection area in a simple manner and which allows the orientation of the sample relative to the optical axis of the objective to be varied in a simple manner.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

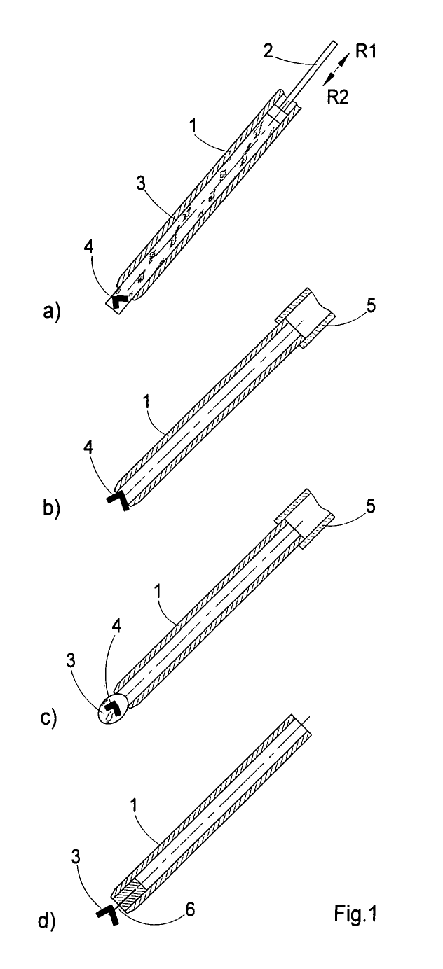

FIG. 1 shows several advantageous constructional variants of a sample holder associated with the arrangement according to the invention. The sample holder 1 according to FIG. 1a has the shape of a hollow cylinder. A suction-and-pushing piston 2 is guided in the cylindrical hollow space of the hollow cylinder so as to be displaceable in directions R1 and R2. When the suction-and-pushing piston 2 is displaced in direction R1, a below-atmospheric pressure can be generated in the hollow space of the sample holder 1, which causes a hydro gel, preferably an agarose gel 3 in which a sample 4 is embedded, to be sucked into the hollow space.

The sample 4 is embedded in the agarose gel 3 in a manner known per se in that the open end portion of the sample holder is immersed in a reservoir in which liquid agarose gel 3 and samples 4 are still initially located. Agarose gel 3 and at least one sample 4 contained therein are sucked out of the reservoir into the hollow space of the sample holder 1 by the displacement of the suction-and-pushing piston 2 in direction R1. Heat is then extracted from the agarose gel 3 located in the hollow space so that the agarose gel 3 solidifies and accordingly fixates the sample 4.

When the suction-and-pushing piston 2 is displaced in direction R2, the solidified agarose gel 3 with the sample 4 is pushed out of the sample holder 1 to the position shown in FIG. 1a. The sample holder 1 and sample 4 are accordingly prepared for use in connection with the arrangement according to the invention as will be shown below.

First, however, the other constructional variants of sample holders 1 shown in FIGS. 1b to 1d will be referred to.

The sample holder according to FIG. 1b is likewise constructed in the shape of a hollow cylinder, but in this case communicates with a vacuum pump, not shown in the drawing, via a hose line 5. A below-atmospheric pressure is formed in the interior of the sample holder 1 by means of the vacuum pump and ensures that the sample 4 is held at the opening of the sample holder 1 remote of the suction line 5.

While only the sample 4 is held at the sample holder 1 in the constructional variant according to FIG. 1b, a sample 4 enclosed in an agarose gel 3 which is already solidified is held at the sample holder 1 in the constructional variant according to FIG. 1c. This is achieved again by means of a below-atmospheric pressure in the interior of the sample holder 1 which is also generated in this case, as in the constructional variant according to FIG. 1b, by a vacuum pump which communicates with the sample holder 1 via a hose line 5.

In the constructional variant according to FIG. 1d, the sample holder 1 is provided with a needle 6 on which the sample 4 is impaled and accordingly affixed to the sample holder 1. In a comparable manner, the sample holder 1 can be outfitted with a clamp which holds the sample 4 in the position shown in the drawing. As in FIG. 1c, the sample can also be embedded in agarose gel.

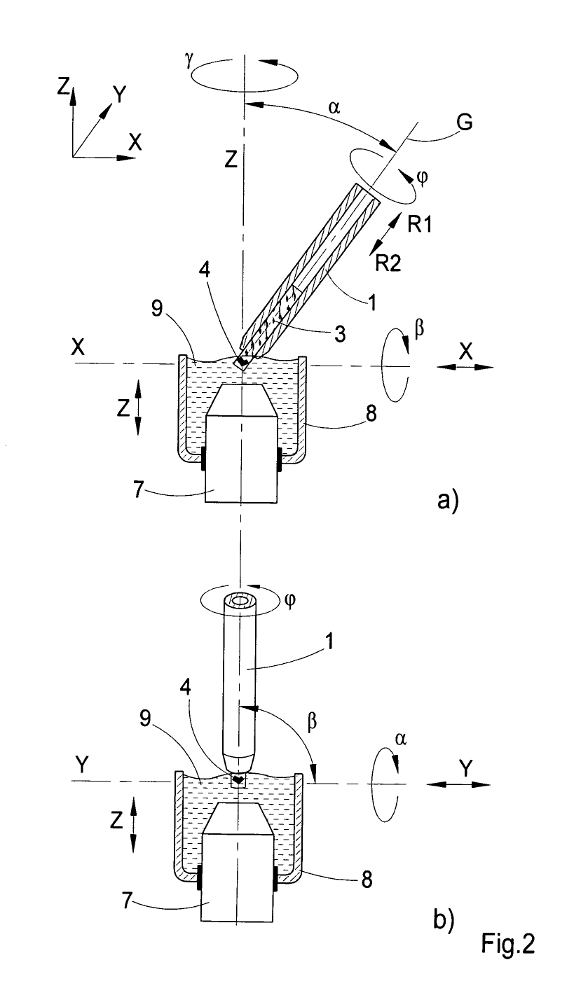

FIG. 2 shows examples of the possibilities for positioning and orienting the sample relative to the microscope objective 7 referring by way of example to a sample 4 affixed to a sample holder according to FIG. 1a.

In accordance with the conditions of single plane illumination microscopy, the microscope objective 7 is immersed in a chamber 8 in which is located an immersion liquid 9 (e.g., water). The refractive index of the agarose gel 3 surrounding the sample 4 should not differ substantially from the refractive index of the immersion liquid 9. The sample 4 is illuminated by a beam path (not shown in the drawing) shaped as a light sheet which is directed to the sample 4 in direction of coordinate Y and, in so doing, penetrates the transparent wall of the chamber 8 and the immersion liquid 9.

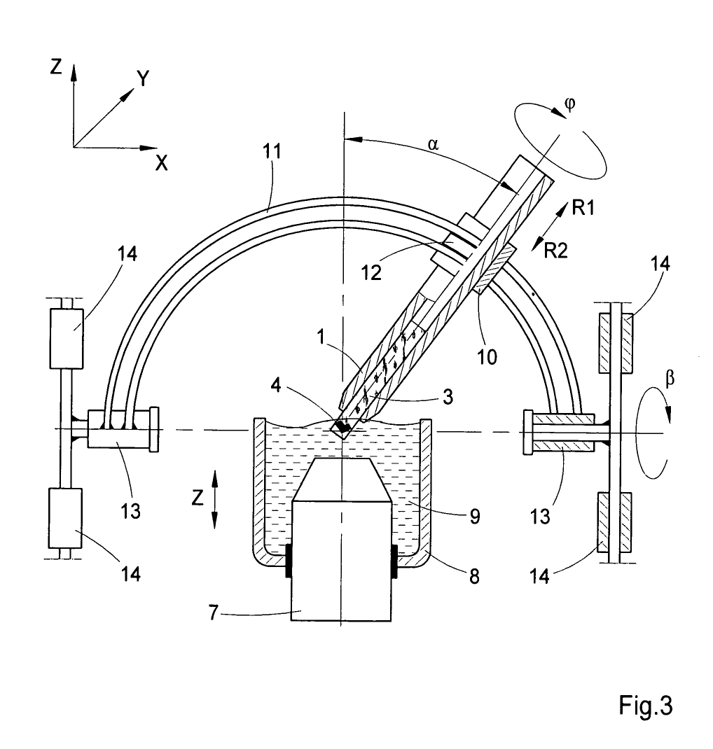

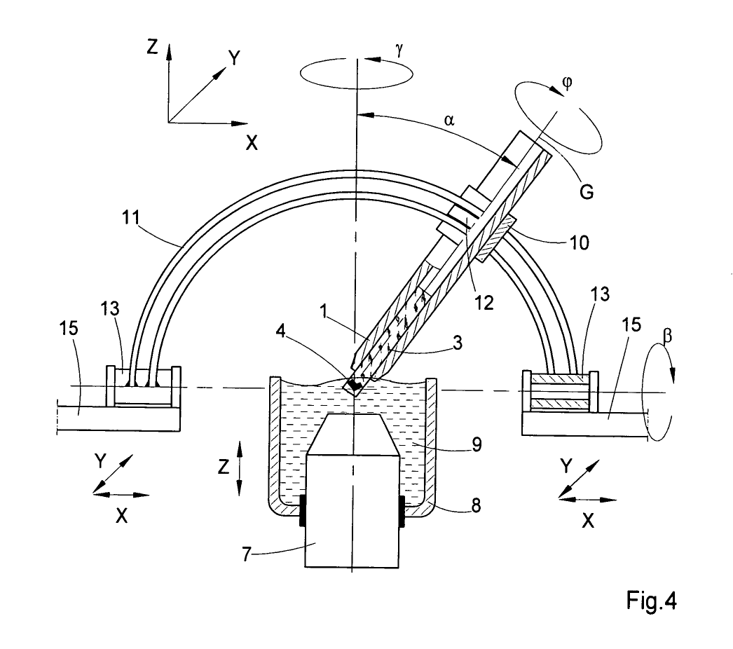

The detection area of the microscope objective 7 is defined by the focus space (not shown) of the microscope objective 7. However, it shall be assumed in the configuration shown in FIGS. 2a and 2b that the sample 4 is already positioned in the detection area of the microscope objective 7. Examples for the positioning of the sample 4 will be described in more detail in the following with reference to FIGS. 3 and 4.

In order to illustrate the degrees of freedom offered by the arrangement according to the invention for positioning and orientation, it is assumed that the detection area of the microscope objective 7 is situated in the origin of a coordinate system X, Y, Z, wherein coordinate Z is defined by the optical axis of the detection objective 7.

To position the sample in this location and, at the same time, allow it to be oriented relative to the microscope objective 7 in such a way that it can be viewed from as many viewing directions as possible, the following movement possibilities are provided according to the invention:
translational movement of the sample holder 1, including the sample 4 affixed thereto, in coordinate directions X, Y, Z so that the point P(x, y, z) upon which the sample 4 lies can be varied relative to the coordinate origin; the range of variation comprehends the detection area;
translational movement of the sample holder 1, including the sample 4 affixed thereto, in directions R1 and R2 along a straight line G which encloses an angle α with coordinate Z, or the optical axis of the microscope objective 7, and which is at the same time the center axis of the sample holder 1 which is constructed as a hollow cylinder;
rotational movement of the sample holder 1, including the sample 4 affixed thereto, around an angle φ, preferably within a range of up to 360°, wherein the straight line G is the axis of rotation;
rotational movement of the sample holder 1, including the sample 4 affixed thereto, around an angle γ, preferably within a range of up to 360°, wherein the axis of rotation is oriented parallel to coordinate Z or to the optical axis of the microscope objective 7 or lies upon it;
rotational movement of the sample holder 1, including the sample 4 affixed thereto, around a straight line which perpendicularly intersects the optical axis of the microscope objective 7 for the purpose of tilting the plane in which angle α is located by an angle β, preferably within an angular range of ±90°.

Angle α lies in the plane which is enclosed by coordinates X and Z and which is at the same time the drawing plane of FIG. 2a. FIG. 21) shows this in a side view; in this case, angle β and the drawing plane lie in the plane enclosed by coordinates Y and Z.

Concrete examples for constructions of the arrangement according to the invention are shown in FIG. 3 and FIG. 4 which will be described in the following.

FIG. 3 shows a first constructional variant of the arrangement according to the invention in which the sample holder 1 is supported in a pivot bearing 10 so as to be rotatable around angle φ. For the purpose of changing the size of the angle α within an angular range of ±90°, a sliding guide 11 is provided in which a sliding block 12 to which the sample holder 1 is fixedly connected is displaceable on a semi-circular path, wherein the sample 4 affixed to the sample holder 1 remains in the vertex of angle α as angle α changes.

Further, pivot bearings 13 are provided which allow the sliding guide 11, including the sample holder 1 with the sample 4 affixed thereto, to be tilted by angle β around a straight line which intersects coordinate Z or the optical axis of the microscope objective 7 at right angles.

Linear guides 14 ensure that the sliding guide 11 together with the sample holder 1 and the sample 4 affixed thereto is displaceable in direction of coordinate Z, while the microscope objective 7 and the chamber 8, including the immersion liquid 9, remain relatively stationary. Simultaneous with this displacement, the position of the vertex of angle α is displaced in direction of coordinate Z.

In a second constructional variant according to FIG. 4, the sample holder 1 is again rotatable around angle φ by means of a pivot bearing 10, where the straight line G forms the axis of rotation, and a change in the size of angle α is possible by means of displacing the sliding block 12 in the sliding guide 11. A change in the size of angle β is likewise provided for by means of the pivot bearing 13.

In this case, however, in contrast to the constructional variant according to FIG. 3, the relative movement between the detection area and the sample holder 1 with the sample 4 affixed thereto is achieved by displacing the microscope objective 7 in direction of coordinate Z, while the sample holder 1 and the sample 4 are stationary in comparison. The displacement of the microscope objective 7 is carried out either with the inclusion of the chamber 8 and the immersion liquid 9 or relative to the chamber 8 and the immersion liquid 9. In the latter case, a sliding seal is provided between the objective and the chamber 8.

Also, contrary to the depiction in FIG. 3, the guide curve of the sliding guide 11, including the pivot bearing 13, is arranged on a table 15 which is displaceable in coordinates X and Y. Optionally, the table 15 can also be supported so as to be rotatable around an axis oriented parallel to coordinate Z and to the optical axis, namely, by an angle γ within a range of up to 360°, as is indicated in FIG. 4.

In the configuration shown in FIG. 4, this axis of rotation lies in coordinate Z or in the optical axis of the microscope objective 7, but its position relative to the latter changes with the displacement of the table 15 in coordinates X and/or Y.

The possibility of displacing the sample holder 1, including the sample 4 affixed thereto, in directions R1 and 2 can be omitted in this case.

It is expressly noted that any other construction allowing the same degrees of freedom in the movement of the sample 4 for purposes of its positioning and orientation is comprehended within the inventive idea.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

1 sample holder
2 suction-and-pushing piston
3 agarose gel
4 sample
5 hose line
6 needle
7 microscope objective
8 chamber
9 immersion liquid
10 pivot bearing
11 sliding guide
12 sliding block
13 pivot bearing
14 linear guides
15 table
α, β, γ, φ angles
G straight line
R1, R2 directions
X, Y, Z coordinates

1. An arrangement configured to hold and position a sample in a detection area of an objective of a microscope, where the detection area is located in a chamber which is filled with an immersion liquid, the arrangement comprising:
a sample holder configured so that the sample may be affixed thereto so that the sample lays upon a point P in a coordinate system X, Y, Z;
wherein coordinate Z is defined by the optical axis of the microscope objective; and
wherein the coordinate origin lies within the detection area;
a device configured to vary the position of point P, including the sample affixed to the sample holder, within the coordinate system X, Y, Z;
wherein the range of variation comprehends the detection area; and
a device configured to rotate the sample affixed to the sample holder around point P;
wherein a straight line G, which encloses with coordinate Z an angle α whose size can be changed, is the axis of rotation.

2. The arrangement according to claim 1, further comprising:
a device configured to displace the sample holder, including the sample affixed thereto, along the straight line G, where the vertex of angle α is included in the displacement path of the sample holder; and
a device configured to displace the position of the vertex of angle α in direction of coordinate Z, where the detection area is included in the displacement path of the vertex of angle α.

3. The arrangement according to claim 1, further comprising:
a device configured to vary the size of angle α.

4. The arrangement according to claim 1, further comprising:
a swiveling device configured to vary the angle β enclosed by coordinate Z and the plane E in which angle α lies, where a swiveling axis of the swiveling device intersects coordinate Z at right angles.

5. The arrangement according to claim 4;
wherein the variation of the size of angle β is provided within a range of β=±90°.

6. The arrangement according to claim 4, further comprising:
a device configured to rotate the swiveling device by an angle γ around an axis parallel to coordinate Z.

7. The arrangement according to claim 1, further comprising:
a device configured to displace the position of point P, including the sample affixed to the sample holder, in direction of coordinate X and/or in direction of coordinate Y.

8. The arrangement according to claim 1;
wherein the sample holder is constructed in the form of a pin or a hollow cylinder, where a center axis of the pin or hollow cylinder lies in the straight line G.

9. The arrangement according to claim 8;
wherein the sample holder is constructed in the form of a hollow cylinder, and is configured to hold the sample because of a below-atmospheric pressure prevailing in the interior of the hollow cylinder.

10. The arrangement according to claim 9;
wherein a hollow space of the hollow cylinder communicates with a vacuum pump or with a displaceable suction-and-pushing piston so as to generate the negative pressure.

11. The arrangement according to claim 8;
wherein the sample holder is constructed in the form of a pin, and is configured to affix the sample to an end of the pin by impaling the sample on the pin.

12. The arrangement according to claim 8;
wherein the sample holder is constructed in the form of a pin, and is configured to affix the sample to an end of the pin by means of a clamp.

13. The arrangement according to claim 1, further comprising:
a hydro gel which is configured to enclose one or more samples affixed to the sample holder.

14. The arrangement according to claim 1;
wherein the device for changing the size of the angle α has a sliding guide with a guide curve which is curved in a half-circle around the vertex of angle α.

15. The arrangement according to claim 14;
wherein the sliding guide is constructed as a subassembly of the swiveling device for varying angle β.

16. The arrangement according to claim 1;
wherein an illumination beam path shaped as a light sheet is configured to be directed to the sample in the direction of coordinate X or coordinate Y in order to illuminate the sample.
